(19) United States
(12) Patent Application Publication
(10) Pub. No.: US 2009/0114363 A1
(43) Pub. Date: May 7, 2009

(54) Component for a Continuous Casting Mold and Method for Producing the Component

(76) Inventors: Albrecht Girgensohn, Dusseldorf (DE); Olaf Thamke, Hilchenbach (DE); Volker Tiepelmann, Hilchenbach (DE)

Correspondence Address: FRIEDRICH KUEFFNER, 317 MADISON AVENUE, SUITE 910, NEW YORK, NY, 10017, US

(21) Appl. No.: 11/991,619

(22) PCT Filed: Aug. 24, 2006
(86) PCT No.: PCT/EP2006/008296

§ 371 Date: Jan. 12, 2009

(30) Foreign Application Priority Data
Sep. 7, 2005 (DE) 10 2005 042 370.1

(51) Int. Cl. B22C 23/00; B23K 28/00; B23K 25/00

(52) U.S. Cl. 164/412; 228/101; 219/73.1

(57) ABSTRACT

The invention relates to a component (1) for a continuous casting mould, such as a water box, adapter plate etc., to which a copper plate is fixed. The component (1) is composed of at least two individual elements (2, 3, 4, 6, 7), consisting of different materials. The invention also relates to a method for producing a component for a continuous casting mould.

The invention concerns a component for a continuous casting mold, such as a water tank, adapter plate, etc., on which a copper plate is mounted, and a method for producing the component.

In continuous casting molds, electromagnetic brakes or stirrers are used to control the flow in the mold, especially in the area of the meniscus. The electromagnetic brakes or stirrers consist of magnetic cores made of a ferromagnetic material, which are wound completely or partially with magnet coils. Magnetic cores and coils can be arranged and connected with each other in various ways to achieve the desired control of the flow in the mold.

In previous solutions, parts of the mold, such as the water tank, are used to guide and control the magnetic flux. This approach is used especially when the magnetic flux is meant to be active only in certain regions of the mold.

In addition, the distance between the ferromagnetic core and the molten metal in the mold must be kept as small as possible, because the intensity of the magnetic field decreases at a greater than proportional rate with increasing distance.

WO 2004/022,264 A1, for example, discloses an electromagnetic braking device for molten steel flowing into a continuous casting mold. It comprises at least one magnet coil with a ferromagnetic core that can be assigned to the broad sides of the mold. In this regard, the core consists, on the one hand, of a primary part, which holds the magnet coil and can be displaced at a distance from the broad side walls, and, on the other hand, of additional parts that are rigidly mounted in the water tanks of the mold, such that when the parts of the core are brought together in their operating position, they form U-shaped yokes for generating a closed magnetic flux, and when they are moved apart into their nonoperating position, they cause the magnetic flux to be interrupted.

EP 1 214 165 B1 discloses a device with an electromagnetic brake for the continuous or discontinuous casting of metals. In this device, the brake comprises at least two magnetic cores, which are located on one side of a mold and are mounted thereon, and a yoke, which is detachably connected with the two magnetic cores and joins them, such that the yoke supports at least one coil essentially between the two magnetic cores that are connected by the yoke. The coil around the yoke is wound in such a way that the central axis of the coil is essentially parallel to a longitudinal side of the mold, that the central axis of the coil extends essentially perpendicularly to the direction of casting in the mold, that the magnetic cores are permanently mounted on the mold, and that the magnetic cores cover essentially the entire width of the mold except for a central segment of the mold.

In these prior art designs, the ferromagnetic cores are arranged in the water tank in such a way that a magnetic field of variable strength is generated over the width of the mold.

EP 0 679 115 B2 describes a method for the continuous casting of molten metal into billets and blooms by means of a device that has a mold into which molten metal is introduced by a process of open-end casting. The performance of induction in the molten metal comprises electromagnetic induction of the stirring of molten metal with an intensity that normally results in turbulence in the molten metal, including its free surface, by applying a rotating magnetic field to the molten metal and applying a second rotating magnetic field, which is generated by a source separate from the source that generates the first magnetic field and in a location upstream of the stirring, such that the first rotating magnetic field rotates in the same direction as the direction of rotation of the first field in order to intensify the stirring motion in the area of the free surface, but applies a torque to the molten metal that is smaller than the torque applied by the first field. This document describes different magnetic fields over the height of the mold for electromagnetic stirrers.

EP 0 820 824 B1 discloses a continuous casting installation with a magnetic field generated in the area of the continuous casting mold, where each central core of a magnet is enclosed by coil windings, and the central cores are connected with one another by a yoke that surrounds the mold. In this regard, each of the magnets that is used has a central core that is divided on the mold side into at least an upper core for an upper magnetic field and a lower core for a lower magnetic field, so that a magnetic field that arises during operation is divided into at least an upper and a lower magnetic field with respect to the continuous casting mold.

EP 0 922 512 A1 discloses a similar device with magnets arranged at a distance.

In these designs, the liquid steel is braked by the magnetic field in the direction of casting only in individual areas.

Both for slab casting machines and thin slab casting machines, there are design solutions in which copper plates of a mold are not mounted directly on the water tank but rather are mounted on an adapter plate. This is described in DE 195 81 604 T1 for CSP gate molds. The copper plate and adapter plate can then be removed together as a cassette and serviced. Of course, the adapter plate must be of a certain thickness, so that it is sufficiently stable and is not too strongly deformed by the copper plate. The distance between the magnetic core and the liquid steel is increased by the thickness of the adapter plate that must be taken into account. For installations with an electromagnetic brake, the previously known adapter plates consist of nonmagnetic, high-grade austenitic steel.

The objective of the invention is to design and simplify the well-known components of a continuous casting mold, such as the water tank, adapter plate, etc., in such a way that the intensity of the magnetic field is increased and its effectiveness is improved and the aforementioned disadvantages are avoided.

In accordance with the invention, this objective is achieved by virtue of the fact that a component of the type described in the introductory clause of Claim 1 is constructed of at least two different materials, with one material being magnetic and the other material being nonmagnetic.

Further refinements of the component are specified in the respective dependent claims.

The invention also concerns a method for producing the component of the invention. In accordance with the invention, the component is produced by welding, in which at least one individual magnetic element is joined with an individual nonmagnetic element.

Further refinements of the method are specified in the respective dependent claims.

The decisive advantage of the method of the invention is that even thick-walled components made of materials with different magnetic properties can be produced by welding. In this regard, it is important that internal stresses do not cause the components to warp during the welding operation, during subsequent machining operations, and during the casting operation. Defects, shrinkage cavities, and cracks in the weld must also be avoided.

In a refinement of the invention, electroslag welding is used. In this welding process, a weld pool is produced between the two individual elements to be welded, which are positioned a few mm from each other. The respective surfaces of the individual elements become partially liquid on contact with the weld pool. In addition, welding wire is supplied to the weld pool. The volume between the individual elements is slowly filled from bottom to top according to the amount of welding wire that is supplied. The weld pool solidifies continuously as welding progresses. During the production of the component, welding is carried out in the longitudinal direction of the seam.

Materials that can be used for the individual elements of the component include, for example, ferromagnetic carbon steels combined with a nonmagnetic austenitic steel.

Materials that are especially well suited are X6CrNiMoTi17-12-2 and S355.

A specific embodiment of the invention will now be described in detail with reference to the highly schematic drawings.

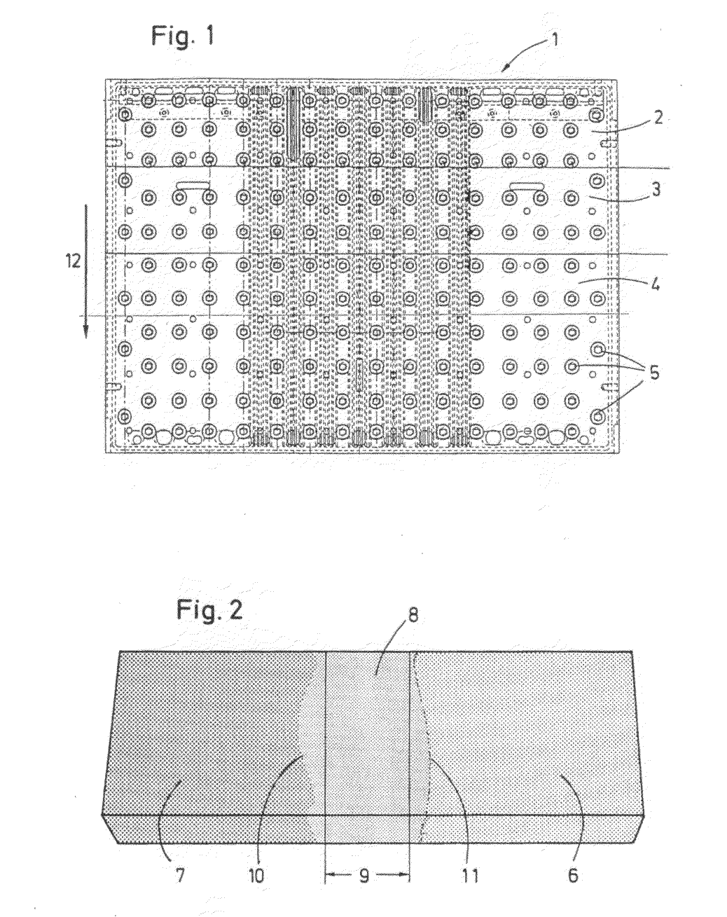

FIG. 1 shows a front elevation of a component (adapter plate) in accordance with the invention.

FIG. 2 shows a cross-sectional micrograph of two individual elements joined by welding.

FIG. 1 shows a front elevation of a component of the invention, for example, an adapter plate 1. The one-piece adapter plate 1 is formed, as viewed in the casting direction 12, by individual elements 2, 3, 4, which are joined, for example, by welding. The individual elements 2 and 4 consist of a nonmagnetic steel, and the individual element 3 consists of a ferromagnetic steel. The width of the individual elements 2, 3, 4 depends on the desired position of the meniscus in the continuous casting mold (not shown). After the individual elements 2, 3, 4 have been welded together, the adapter plate 1 is furnished with through holes or threaded bores 5 for fastening a copper plate (not shown) to it.

FIG. 2 is a cross-sectional micrograph showing the three different regions of an adapter plate of the invention. On the right side is seen, for example, an individual element 6 made of a nonmagnetic, high-grade austenitic steel (X6CrNiMoTi17-12-2), and on the left side an individual element 7 made of a ferromagnetic carbon steel (S355). A broad region that constitutes the actual weld seam 8 is located between the right individual element 6 and the left individual element 7. The distance 9 originally set between the two individual elements 6, 7 is smaller than the weld seam 8 that has ultimately formed, and the original rectilinear seam geometry between the individual elements 6, 7 has expanded into the shape of a barrel. The dividing lines 10, 11 between the weld seam 8 and the individual elements 6, 7 run similarly on both sides.

The entire area of the weld seam 8 has the same magnetic properties as the high-grade austenitic steel. The mechanical characteristics of the welded joint reflect properties of both of the base steels.

### LIST OF REFERENCE NUMBERS

1 adapter plate

2 individual element

3 individual element

4 individual element

5 bores

6 right individual element

7 left individual element

8 weld seam

9 distance

10 dividing line

11 dividing line

12 casting direction

1. A component (1) for a continuous casting mold, on which a copper plate is mounted, wherein the component (1) is constructed from at least two individual elements (2, 3, 4, 6, 7) that are made of different materials and are welded together.

2. A component (1) in accordance with claim 1, wherein one individual element (2, 3, 4, 6, 7) is made of a ferromagnetic carbon steel, and the other individual element (2, 3, 4, 6, 7) is made of a nonmagnetic, austenitic steel.

3. A component (1) in accordance with claim 2, wherein one individual element (2, 3, 4, 6, 7) is made of the material X6CrNiMoTi17-12-2, and the other individual element (2, 3, 4, 6, 7) is made of the material S355.

4. A component (1) in accordance with claim 1, wherein a ferromagnetic individual element (2, 3, 4, 6, 7), as viewed in the direction of casting, is designed to be arranged at the level of the meniscus.

5. A component (1) in accordance with claim 1, wherein the component (1) is constructed by welding together individual elements (2, 3, 4, 6, 7).

6. A method for producing a component for a continuous casting mold in accordance with claim 1, wherein the component (1) is produced by welding.

7. A method in accordance with claim 6, wherein the component (1) is produced by electroslag welding.

8. A method in accordance with claim 6, wherein the welding is carried out in the longitudinal direction of the seam.
